(19) United States
(12) Patent Application Publication
(10) Pub. No.: US 2013/0146538 A1
(43) Pub. Date: Jun. 13, 2013

(54) BLEND POLYMERIC MEMBRANES COMPRISING TETRAZOLE-FUNCTIONALIZED POLYMER OF INTRINSIC MICROPOROSITY AND POLYETHYLENE GLYCOL

(71) Applicant: UOP LLC, Des Plaines, IL (US)

(72) Inventors: Chunqing Liu, Arlington Heights, IL (US); Mark E. Schott, Palatine, IL (US)

(73) Assignee: UOP LLC, Des Plaines, IL (US)

(21) Appl. No.: 13/654,532

(22) Filed: Oct. 18, 2012

Related U.S. Application Data
(60) Provisional application No. 61/568,367, filed on Dec. 8, 2011.

(51) Int. Cl. B01D 71/06; B01D 69/06; B01D 69/08; B01D 69/12; B01D 61/00; B01D 53/22

(52) U.S. Cl. 210/650; 95/45; 95/51; 95/54; 95/47; 95/52; 95/49; 95/53; 95/50; 210/500.28; 210/500.23; 210/490; 96/13; 96/10; 96/14

(57) ABSTRACT

The present invention is for high permeance and high selectivity blend polymeric membranes comprising poly(ethylene glycol) (PEG) and a highly permeable polymer selected from the group consisting of polymers of intrinsic microporosity (PIMs), tetrazole-functionalized polymers of intrinsic microporosity (TZPIMs), or mixtures thereof. The present invention also involves the use of such membranes for separations of liquids and gases.

### CROSS-REFERENCE TO RELATED APPLICATION

This application claims priority from Provisional Application No. 61/568,367 filed Dec. 8, 2011, the contents of which are hereby incorporated by reference.

### BACKGROUND OF THE INVENTION

Recently, McKeown et al. reported the synthesis of a new type of polymer, termed polymers of intrinsic microporosity (PIMs), with a randomly contorted molecular structure, bridging the void between microporous and polymeric materials. The rotational freedom of these PIM materials has been removed from the polymer backbone. These polymers exhibit properties analogous to those of conventional microporous materials including large and accessible surface areas, interconnected micropores of less than 2 nm in size, as well as high chemical and thermal stability, but, in addition, possess some favorable properties of conventional polymers including good solubility and easy processability for the preparation of polymeric membranes. Polymeric membranes have been prepared directly from some of these PIMs and both the liquid and gas separation performances have been evaluated. Membranes from PIMs have shown exceptional properties (e.g. extremely high gas permeability) for separation of commercially important gas pairs, including O₂/N₂ and CO₂/CH₄. The exceptionally high permeability of gases arises from the rigid but contorted molecular structures of PIMs, frustrating packing and creating free volume, coupled with chemical functionality giving strong intermolecular interactions. Two published PCT patent applications provide further detail: WO 2005/012397 A2 and WO 2005/113121 A1, both applications incorporated by reference in their entireties. Membranes from PIMs, however, have much lower selectivities for commercially important gas pairs, such as O₂/N₂ and CO₂/CH₄, although their gas permeabilities are significantly higher than those of commercial polymeric membranes from glassy polymers such as CA, polyimides, and polyetherimides.

Most recently, Guiver et al. reported CO₂-philic tetrazole group functionalized polymer nanosieve membranes (TZPIMs) for CO₂-capture applications. The TZPIM membrane materials were prepared by [2+3] cycloaddition modification of PIM-1 polymer containing an aromatic nitrile group with an azide compound. The TZPIM membranes showed enhanced CO₂-philic separation selectivities due to interactions between CO₂ and the tetrazole compared to PIM-1 membrane. See NATURE MATER., 2011, 10, 372.

The present invention discloses a new type of blend polymeric membranes comprising poly(ethylene glycol) and a highly permeable polymer selected from the group consisting of polymers of intrinsic microporosity (PIMs), tetrazole-functionalized polymers of intrinsic microporosity (TZPIMs), or mixtures thereof.

The following diagrams illustrate the preparation and structures of PIM-1 polymer and the TZPIM polymer, respectively.

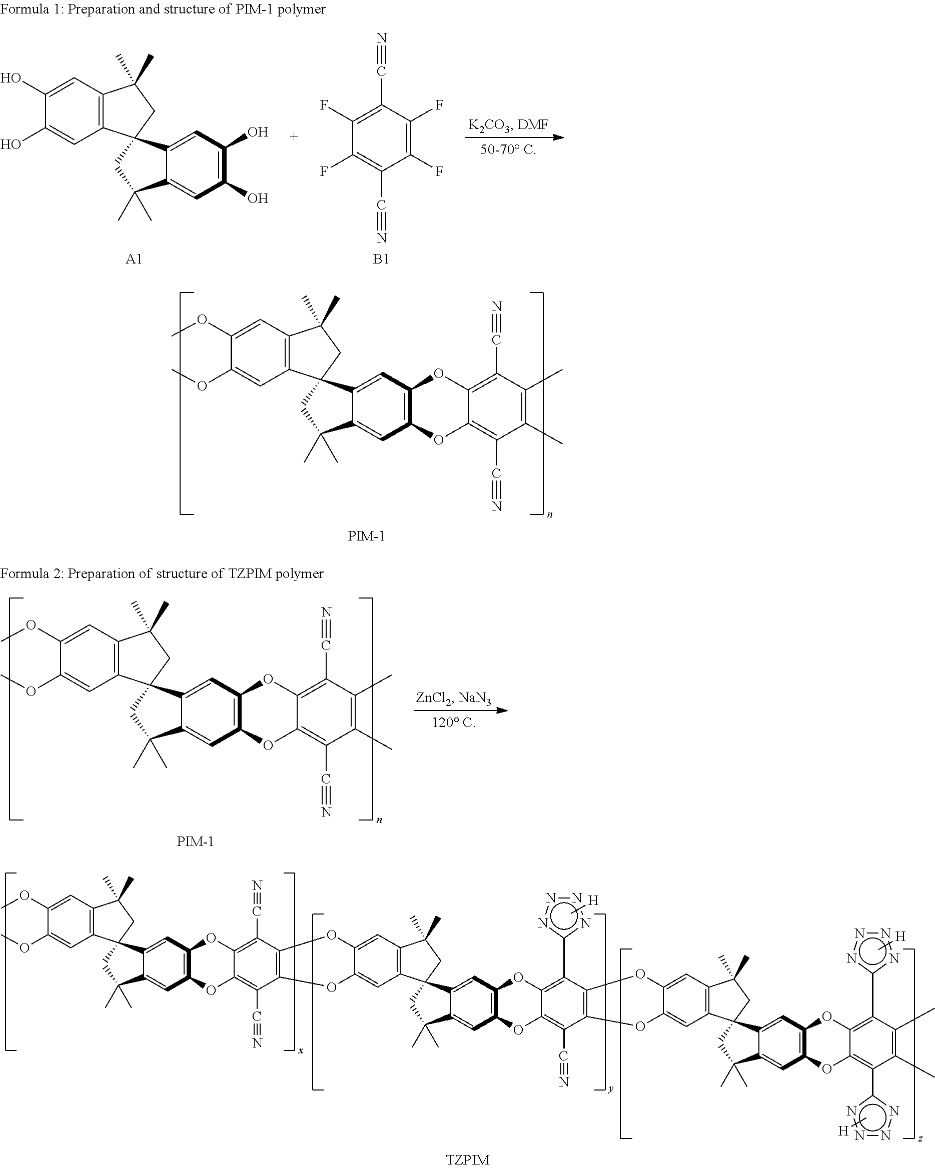

### DESCRIPTION OF THE INVENTION

The present invention is for high permeance and high selectivity blend polymeric membranes comprising poly(ethylene glycol) (PEG) and a highly permeable polymer selected from the group consisting of polymers of intrinsic microporosity (PIMs), tetrazole-functionalized polymers of intrinsic microporosity (TZPIMs), or mixtures thereof. The present invention also involves the use of such membranes for separations. More specifically, the invention involves the methods of making such membranes.

The new blend polymeric membranes comprising PEG and a highly permeable polymer selected from the group consisting of PIMs, TZPIMs, or mixtures thereof have superior separation performance such as high selectivity, high permeability, good mechanical stability, and good long-term performance stability. The poly(ethylene glycol) polymer in the blend membrane can be selected from poly(ethylene glycol) (PEG), poly(ethylene oxide) (PEO), poly(propylene glycol)-block-poly(ethylene glycol)-block-poly(propylene glycol) bis(2-aminepropyl ether)s (PAPE), poly(propylene glycol) bis(2-aminepropyl ether)s, O,O′-bis(3-aminopropyl)polyethylene glycol, polyethylene glycol methyl ether, polyethylene glycol dimethyl ether, polyethylene glycol allyl ether, polyethylene glycol divinyl ether, polyethylene glycol allylmethyl ether, polyethylene glycol butyl ether, polyethylene glycol dibutyl ether, dendritic PEO, hyperbranched amine-terminated PEO, poly(propylene oxide)s (PPO), co-block-poly(ethylene oxide)-poly(propylene oxide)s (PEO-PPO), tri-block-poly(propylene oxide)-poly(ethylene oxide)-poly(propylene oxide)s (PPO-PEO-PPO), and mixtures thereof.

The new blend polymeric membranes comprising PEG and a highly permeable polymer selected from the group consisting of PIMs, TZPIMs, or mixtures thereof were prepared by incorporating two different types of polymers into one membrane with a certain weight ratio of the two polymers selected based upon the separation properties sought.

The blend polymeric membranes comprising PEG and a highly permeable polymer selected from the group consisting of PIMs, TZPIMs, or mixtures thereof of the present invention can be fabricated into any convenient form such as sheets, tubes or hollow fibers. These membranes can also be fabricated into thin film composite membranes comprising a selective thin layer of a blend of PEG and a highly permeable polymer selected from the group consisting of PIMs, TZPIMs, or mixtures thereof and a porous supporting layer of an inorganic material or a polymeric material different from the blend of PEG and a highly permeable polymer selected from the group consisting of PIMs, TZPIMs, or mixtures thereof.

The blend polymeric membranes of the present invention are especially useful in the purification, separation or adsorption of a particular species in the liquid or gas phase.

The blend polymeric membranes of the present invention are especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ from H₂, flue gas or natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the blend polymeric membranes described herein. More than two gases can be removed from a third gas. For example, some of the gas components which can be selectively removed from a raw natural gas using the membranes described herein include carbon dioxide, oxygen, nitrogen, water vapor, hydrogen sulfide, helium, and other trace gases. Some of the gas components that can be selectively retained include hydrocarbon gases.

1. A blend polymeric membrane comprising a poly(ethylene glycol) containing polymer and a highly permeable polymer selected from the group consisting of polymers of intrinsic microporosity (PIMs), tetrazole-functionalized polymers of intrinsic microporosity (TZPIMs), and mixtures thereof.

2. The blend polymeric membrane of claim 1 wherein said poly(ethylene glycol) containing polymer and said highly permeable polymer are present at a weight ratio from about 95:1 to 1:95.

3. The blend polymeric membrane of claim 1 wherein said poly(ethylene glycol) containing polymer and said highly permeable polymer are present at a weight ratio from about 50:1 to 1:50.

4. The blend polymeric membrane of claim 1 wherein said poly(ethylene glycol) containing polymer is selected from the group consisting of poly(ethylene glycol) (PEG), poly(ethylene oxide) (PEO), poly(propylene glycol)-block-poly(ethylene glycol)-block-poly(propylene glycol) bis(2-aminepropyl ether)s (PAPE), poly(propylene glycol) bis(2-aminepropyl ether)s, O,O′-bis(3-aminopropyl)polyethylene glycol, polyethylene glycol methyl ether, polyethylene glycol dimethyl ether, polyethylene glycol allyl ether, polyethylene glycol divinyl ether, polyethylene glycol allylmethyl ether, polyethylene glycol butyl ether, polyethylene glycol dibutyl ether, dendritic PEO, hyperbranched amine-terminated PEO, poly(propylene oxide)s (PPO), co-block-poly(ethylene oxide)-poly(propylene oxide)s (PEO-PPO), tri-block-poly(propylene oxide)-poly(ethylene oxide)-poly(propylene oxide)s (PPO-PEO-PPO), and mixtures thereof.

5. The blend polymeric membrane of claim 1 wherein said membrane is fabricated into a sheet, tube, or hollow fibers.

6. The blend polymeric membrane of claim 1 wherein said membrane is a thin film composite membrane.

7. A process of separating at least two gases or two liquids comprising contacting said gases or liquids with a membrane comprising a blend polymeric membrane comprising a poly(ethylene glycol) containing polymer and a highly permeable polymer selected from the group consisting of polymers of intrinsic microporosity (PIMs), tetrazole-functionalized polymers of intrinsic microporosity (TZPIMs), and mixtures thereof.

8. The process of claim 7 wherein said poly(ethylene glycol containing polymer is selected from the group consisting of of poly(ethylene glycol) (PEG), poly(ethylene oxide) (PEO), poly(propylene glycol)-block-poly(ethylene glycol)-block-poly(propylene glycol) bis(2-aminepropyl ether)s (PAPE), poly(propylene glycol) bis(2-aminepropyl ether)s, O,O′-bis(3-aminopropyl)polyethylene glycol, polyethylene glycol methyl ether, polyethylene glycol dimethyl ether, polyethylene glycol allyl ether, polyethylene glycol divinyl ether, polyethylene glycol allylmethyl ether, polyethylene glycol butyl ether, polyethylene glycol dibutyl ether, dendritic PEO, hyperbranched amine-terminated PEO, poly(propylene oxide)s (PPO), co-block-poly(ethylene oxide)-poly(propylene oxide)s (PEO-PPO), tri-block-poly(propylene oxide)-poly(ethylene oxide)-poly(propylene oxide)s (PPO-PEO-PPO), and mixtures thereof.

9. The process of claim 7 wherein said gases are separated from natural gas and comprise one or more gases selected from the group consisting of carbon dioxide, oxygen, nitrogen, water vapor, hydrogen sulfide and helium.

10. The process of claim 7 wherein said gases are volatile organic compounds.

11. The process of claim 10 wherein said volatile organic compounds are selected from the group consisting of toluene, xylene and acetone.

12. The process of claim 7 wherein said gases comprise a mixture of carbon dioxide and at least one gas selected from hydrogen, flue gas and natural gas.

13. The process of claim 7 wherein said gases are a mixture of olefins and paraffins or iso and normal paraffins.

14. The process of claim 7 wherein said gases comprise a mixture of gases selected from the group consisting of nitrogen and oxygen, carbon dioxide and methane, hydrogen and methane or carbon monoxide, helium and methane.
